(19) United States
(12) Patent Application Publication
(10) Pub. No.: US 2005/0103170 A1
(43) Pub. Date: May 19, 2005

(54) Hydroligripcut pliers

(76) Inventor: Norberto Del Rio, Florida City, FL (US)

Correspondence Address: Norberto Del Rio;Suite #122, 6451 N. Federal Highway, Ft. Lauderdale, FL, 33308, US

(21) Appl. No.: 10/716,131

(22) Filed: Nov. 18, 2003

(51) Int. Cl. B25B 7/00

(52) U.S. Cl. 81/301

(57) ABSTRACT

A comfortable and easy-to-use tool and of the type having a hollow shaft (10), housing a hydraulic system comprising of a spring (22), a toothed piston rod (30), a sealing bolt (28), an intake tuyere (32), and a pressure release valve (12). That in conjunction with the jaw's 14L and 14AR, facilitate the tightening and loosening of bolts, screws, nuts, etc. . . . And to finalize, the cutting of pipes and certain objects. In addition, an air comfort handgrip handle (54) with the use of the air comfort hand grip (56) adds continuous comfort while using the tool. An extendable neck comprising of a system with an extension push button (42), an extension push button fastening screw (42A) and a curved flat spring (44) supply a means for application of more torque.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to tools, specially to an improved pair of grip pliers.

2. Background of the Invention

Originally basic grip pliers come in 3 sizes 5″, 7″, and 10″ and are made with one fixed jaw and a movable jaw, limiting the amount of pressure that can be applied. They manually adjust to size of the object to be tightened or loosened. Only manual pressure can be applied which also limits the amount of pressure that can be applied. If more torque is needed none can be applied due to the length of the grip pliers. When tightening or loosening, once extent of positive motion is met, one has to release pressure of grip due to the absence of negative motion and reapply it.

This invention brings solutions to these disadvantages.

Objects and Advantages

Accordingly, several objects and advantages of the present invention are:
(a) to provide an easy, convenient and comfortable tool to use;
(b) to provide a tool with a hydraulic system that applies an unlimited amount of grip pressure;
\mathring{c}) to provide an extendable neck for the application of more torque;
(d) to provide jaws equipped with a system similar to that of a ratchet;
(e) to provide a tool that serves as grip pliers and a pipe cutter.

Still further objects and advantages will become apparent from a consideration of the ensuring description and drawings.

### DRAWINGS

In the drawings, closely related figures have the same number but different alphabetic suffixes.

FIG. 1 shows a full scale view of the invention.

FIG. 2 shows an exploded view of the invention.

FIGS. 2A to 2J shows different aspects and blown up views of this invention.

FIGS. 3A to 3C show the invention in working positions and blown up view of a certain part.

FIG. 4 shows a perspective view in a tightening position.

FIG. 4A shows a perspective view in a loosening positive.

FIG. 5 shows a perspective view of the invention in an extended position.

FIG. 5A shows a blown up internal view of the extension system.

FIG. 6 shows a front and rear view.

FIG. 7 shows the housing units and certain parts.

### DRAWINGS—REFERENCE NUMERALS

8—main housing
8A—respitory
8B—spring groove
8C—grooved bore
10—hollow shaft
10A—adjustment rack
10B—pressure release tuyere
10C—jaw mount
10D—female coupling
10E—female coupling
12—pressure release valve
14—jaw L
14A—jaw R
16—jaw fastening screw
18—grip cog
20—grip cog fastening screw
22—spring
24—cutter disc
26—cutter disc fastening screw
28—sealing bolt
30—toothed piston rod
32—intake tuyere
34—spring
36—air push piston
38—toothed pressure handle
40—pressure handle fastening screw
42—extension push button
42A—extension push button fastening screw
44—curved flat spring
46—obturator
48—spring
50—air valve
52—extension neck
54—air comfort hand grip handle
56—air comfort hand grip pump

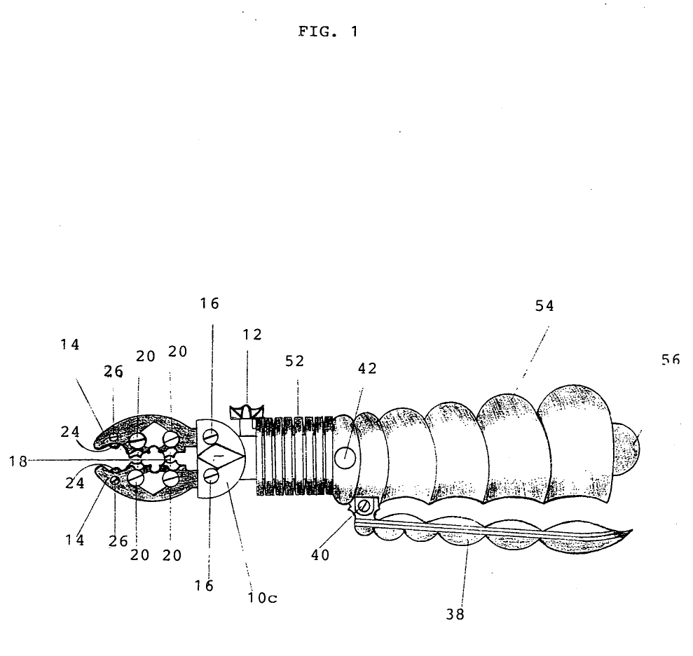

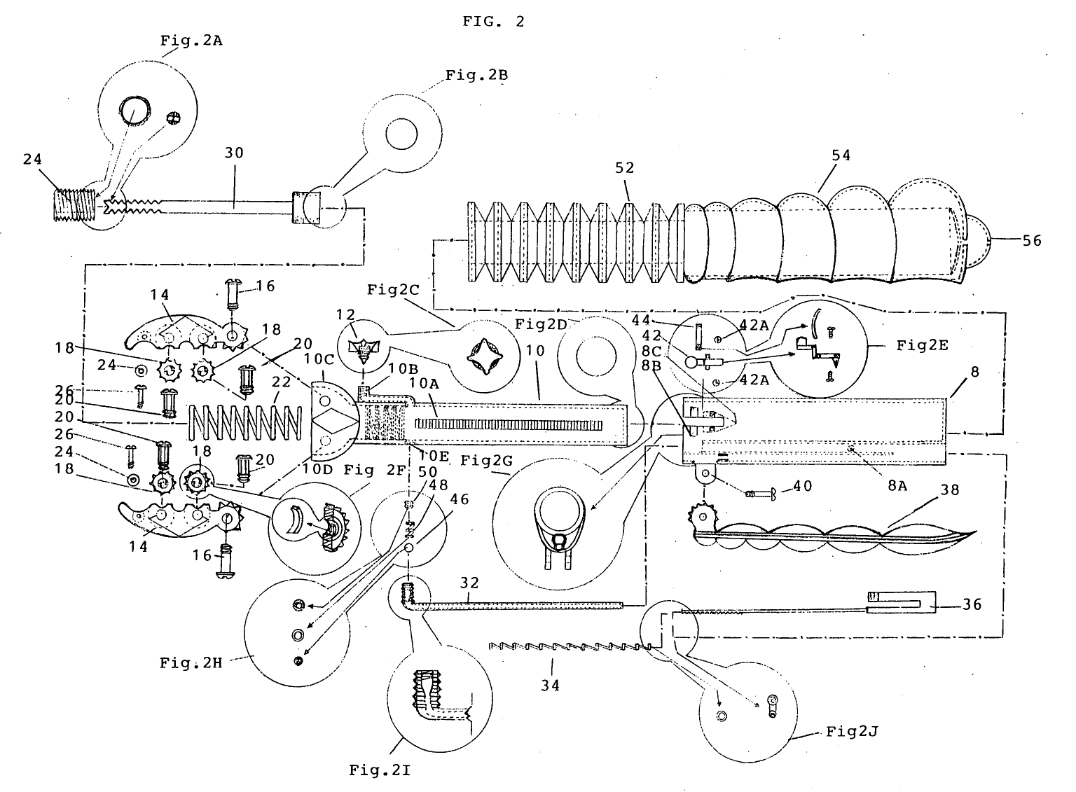

### DETAILED DESCRIPTION—FIGS. 1, 2, 2A TO 2J—PREFERRED EMBODIMENT

A preferred embodiment of the present invention is illustrated in FIG. 1. FIG. 2 shows an (exploded view) of the basic version of my tool. My tool has a main housing 8 which is equipped with a respitory hole 8A. The main housing 8 accommodates an intake tuyere 32, which slides in through the middle slot as illustrated in (FIG. 2G). The main housing 8 also has a spring groove 8B, which accommodates a curved flat spring 44. Also on the main housing 8 is a grooved bore 8C which accommodates an extension push button 42. You place the curved flat spring 44 in the spring groove 8b. You then insert the extension push button 42 in the grooved bore 8c, then slide in toward distal end. Which is then anchored in place with a pair of extension push button fastening screws 42A. A spring 34 is used in conjunction with an air pump piston 36, which is equipped with a toothed rod. The toothed rod of the air pump piston 36 slides in through the spring 34. Next the spring 34 and the air pump piston 36 slide in through the bottom back end opening of the main housing 8. A toothed pressure handle 38 is fastened to the main housing 8 with a pressure handle fastening screw 40.

A hollow shaft 10 houses a spring 22 which is inserted first. Followed by a toothed piston rod 30. The chamber is sealed off with a seal bolt 28. The seal bolt 28 has a cavity through it, for which the toothed piston rod 30 slides through, while screwing on the seal bolt 28 sealing off the chamber. A pair of jaws 14L and 14AR accommodates a pair of grip cogs 18 which are each fastened to both jaws 14L and 14AR. Also both jaws 14L and 14AR accommodate cutter disc 24, each of which are fastened with a cutter disc fastening screw 26. Both jaws 14L and 14AR are fastened to a jaw mount 10C on the hollow shaft 10 with a pair of jaw fastening screw 16. The intake tuyere 32 accommodates an obturator 46, a spring 48, and an air valve 50. The obturator is placed in the threaded end of the intake tuyere 32. A blown up view is illustrated in (FIG. 2I). Followed by the spring 48 and sealed off with the air valve 50. The air valve 50 has a cavity which runs through it. The intake tuyere 32 screws onto the hollow shaft 10 through a female coupling 10E. Along the top of the hollow shaft 10 runs a longitudinal indented toothed groove 10A. Along the side is a pressure release tuyere 10B, which is sealed off with a pressure release valve 12. The completely assembled hollow shaft 10 slides into the main housing 8, as illustrated in (FIG. 2), which is covered with an extension neck 52 and an air comfort hand grip handle. The hollow shaft 10 is served to the main housing 8 through the extension push button 42. On the back end of the handle is an air comfort hand grip pump 56.

### OPERATION OF INVENTION—FIGS. 2F, 3-3C, 4; 4A; 5A

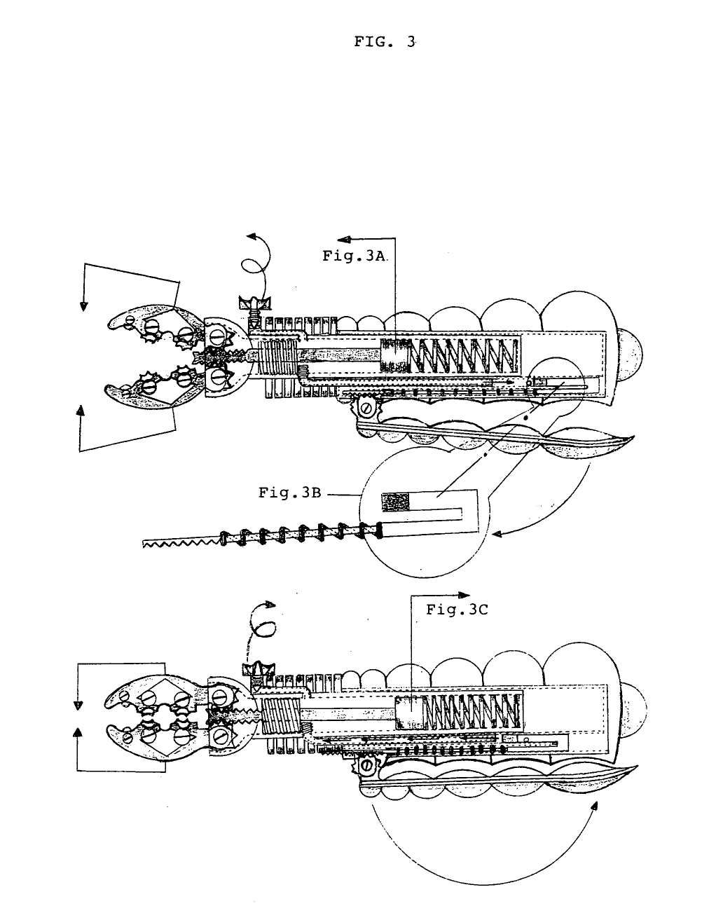

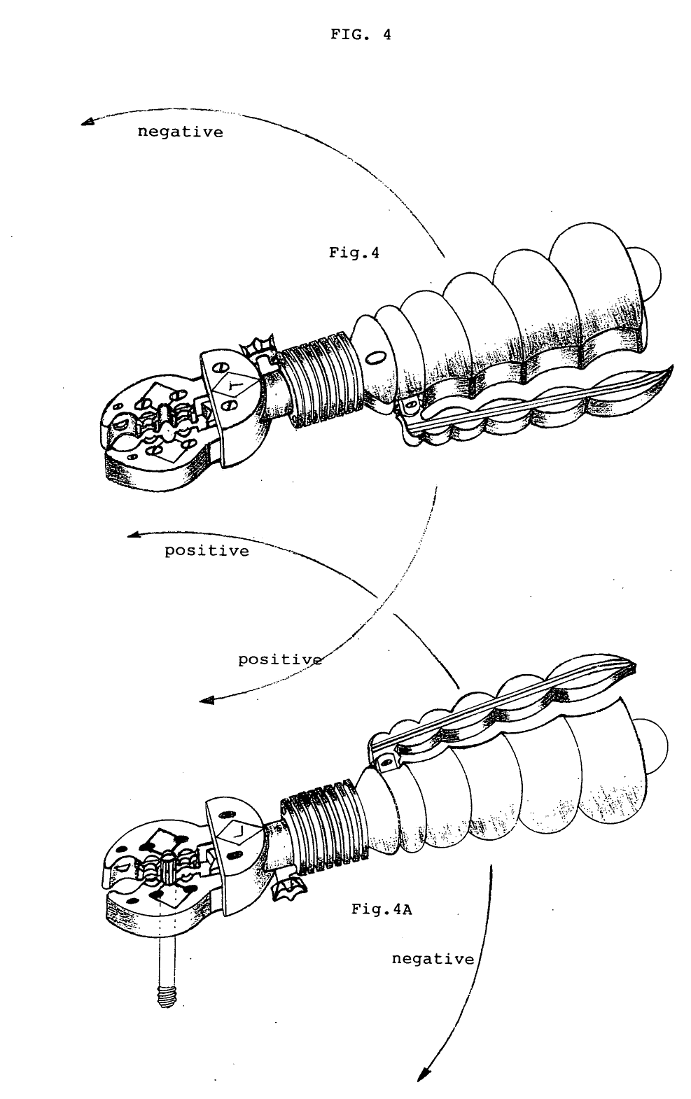

The manner of using the Hydroligripcut Pliers is different to that of conventional grip pliers in present use. Namely, one first unscrews the pressure release valve 12 in a counter clock wise direction. Next, you fill the hollow shaft 10 with the recommended fluid. When recommended level is met, you screw the pressure release valve on in a clock wise direction. Now it is ready for use. Next, one positions the jaw 14L and 14AR around the object-as illustrated in (FIG. 4a). One then squeezes down the pressure handle 38 as illustrated in (FIG. 3C). The teeth on the mounting piece of the pressure handle, moves along the teeth of the air push piston 36. Which in turn pushes the air sucked in through the respitory hole 8A. The air being pushed through the intake tuyere 32 as illustrated in (FIG. 3C), pushes up the obturator 46 pushes up the spring 48 which allows the air to pass through the air valve 50. The air that passes through the air valve 50 pushes on the fluid. The fluid pushes the toothed piston rod 30 as illustrated in (FIG. 3C), to the distal end of the hollow shaft 10. By pushing the toothed piston rod 30 the teeth of the toothed piston rod 30 grip the teeth of the jaws 14L and 14AR. With the movement of the teeth the jaws 14L and 14AR in turn close around the object. The spring 34 on the air push piston 36 pushes back the air push button 36, which in turn, returns the toothed pressure handle 38 to its starting position. While returning to starting position the air is sucked through the respitory hole 8A. The process is repeated until jaws 14L and 14AR clamp around object, until desired pressure is met.

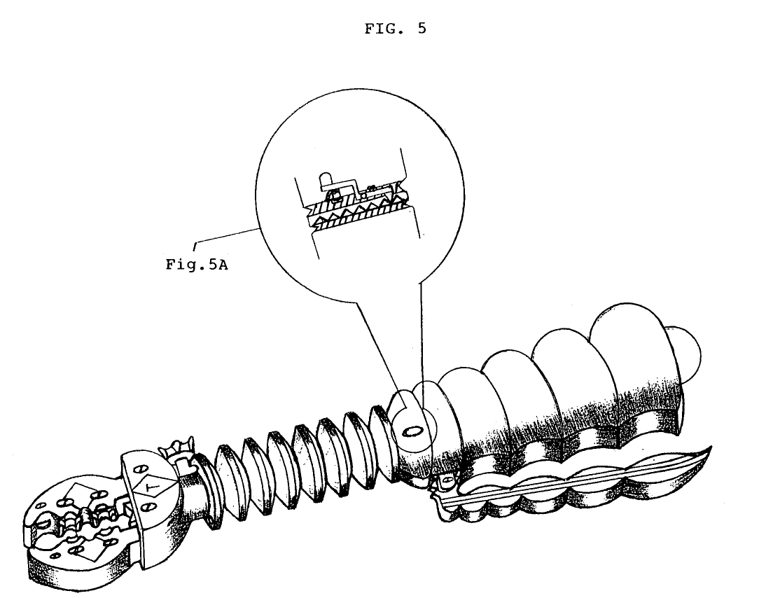

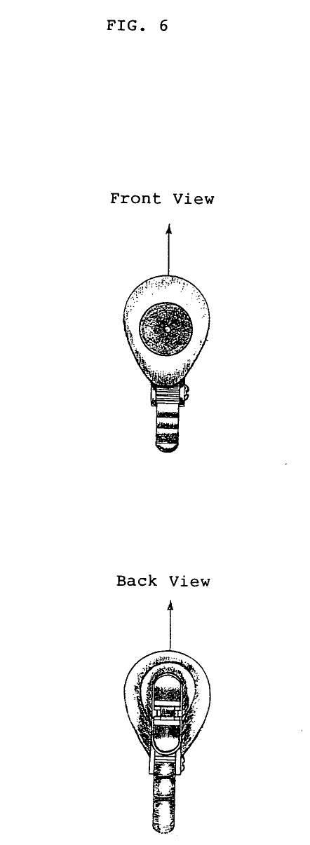

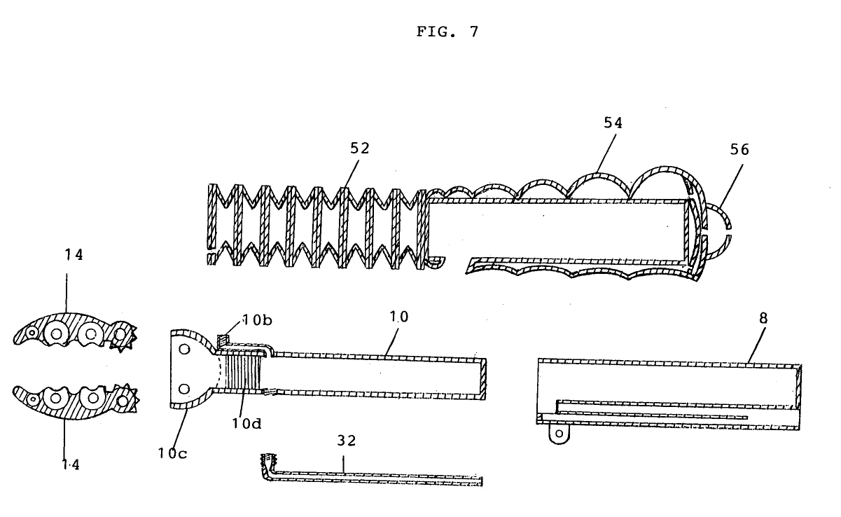

Once desired pressure is met, to tightened object as illustrated in (FIG. 3C). One swings invention as illustrated in (FIG. 4) using positive motion. Once full motion is met, one does not have to release jaw pressure, one simply swings invention the negative motion as illustrated in (FIG. 4). The grip cogs 18 use an internal mechanism similar to that of a ratchet as illustrated in (FIG. 2F). Next you swing back using positive motion, and so forth. If in need of applying more torque, one simply pushes down the extension push button 42. Then pulling on handle while extension push button 42 is pressed as illustrated in (FIG. 5A). The extension push button 42 raises tooth end allowing it to rake down toothed groove 10A till desired length is met. Once desired length is met, one releases extension push button 42. The curved flat spring 44 pushes up extension push button 42 locking the tooth in place as illustrated in (FIG. 5A).

To release pressure one partially unscrews pressure release valve 12 by turning it counter clock wise as illustrated in (FIG. 3A). By releasing the air pressure, the spring 32 pushes on toothed piston rod 30. The toothed piston rods 30 teeth move the jaws 14L and 14AR, opening the jaws 14L and 14AR.

To distinguish between which side tightens and which one loosens, the jaw mount 10C, a diamond shape, has the letter “T” engraved on it for tightening, and the opposing side, has the letter “L” for loosening.

The invention can be used to create a gripping head on bolts with a broken off head as illustrated in (FIG. 4A). One simply uses the steps one would take to close jaws 14L and 14AR to tighten or loosen a bolt. Namely, one just keeps applying pressure till a gripping head is formed. To cut pipes, one first places pipe to be cut between cutter and discs 24 at the tip of jaws 14L and 14AR. Then one would simply repeat steps as closing jaws 14L and 14AR around an object. Next you would apply pressure till cutter discs 24 penetrates pipe surface. Finally, once surface is penetrated, one would then swing invention in a positive motion till pipe is cut. To apply more torque, one extends invention as illustrated in (FIG. 5A).

### Conclusions, Ramifications, and Scope of Invention

Accordingly, the reader will see that the jaw grip of this invention can be used easily and conveniently to tighten or loosen objects and to cut pipes. In addition, when a bolt does not have a head, the invention can be used to create an easy to grip head for the bolt. Also, accordingly the scope of the invention should be determined not by the embodiment(s), but by the appended claims and their legal equivalents.

1. A device for the use of tightening or loosening objects, comprising:
(A) a body consisting of a pair of jaws enabling the function of tightening, loosening, and cutting of objects,
(B) providing a hydraulic system with means for coupling the function of said jaws, \mathring{C}) side body having a hole near its distal end substantially aiding the use of said hydraulic system,
(D) whereby all components provide the result, for which the device is used for.
